(19) United States
(12) Patent Application Publication
(10) Pub. No.: US 2025/0044600 A1
(43) Pub. Date: Feb. 6, 2025

(54) OPTICAL ASSEMBLY

(71) Applicant: Apple Inc., Cupertino, CA (US)

(72) Inventors: Chenchen Shen, San Jose, CA (US); Nawaf Al-Baghly, San Jose, CA (US); Chih Jen Chen, San Jose, CA (US)

(21) Appl. No.: 18/614,425

(22) Filed: Mar. 22, 2024

Related U.S. Application Data
(60) Provisional application No. 63/497,940, filed on Apr. 24, 2023.

(51) Int. Cl. G02B 27/01

(52) U.S. Cl. CPC G02B 27/0176; G02B 27/0172; G02B 2027/0154; G02B 2027/0161; G02B 2027/0178

(57) ABSTRACT

A glasses assembly can include a front cover, a suspension, and a waveguide held by the suspension. The front cover and the waveguide can define a gap. The glasses assembly can include a shroud at least partially disposed in the gap. The shroud can define a first end and a second end. The shroud can include an elastomer body and a core coupled with the front cover at the first end of the shroud.

### CROSS REFERENCE TO RELATED APPLICATION(S)

This claims the benefit of priority to U.S. Provisional Patent Application No. 63/497,940, filed 24 Apr. 2023, entitled “OPTICAL ASSEMBLY”, the disclosure of which is hereby incorporated by reference in its entirety.

### FIELD

The described embodiments relate generally to an optical assembly. More particularly, the present embodiments relate to a waveguide bumper assembly for glasses.

### BACKGROUND

Recent advances in the extended reality (XR) and the electronics industry have enabled glasses assemblies to project digital information onto wearable lenses. Typically, glasses assemblies for XR systems include various components to display the digital information. As such, to incorporate the numerous components in the glasses assembly, the components can be thin and delicate. During use, as glasses are moved, donned, and doffed, the various components can come into contact with each other and other surfaces, such as a floor or other surfaces when dropped or set down. Thus, glasses assemblies designed to reduce the impact force on the components from contact with other components and surfaces are needed.

### SUMMARY

In at least one example of the present disclosure, a glasses assembly includes a front cover, a suspension, and a waveguide held by the suspension. The front cover and the waveguide defining a gap. The glasses assembly includes a shroud at least partially disposed in the gap and defining a first end and a second end. The shroud includes an elastomer body and a core coupled with the front cover at the first end of the shroud.

In one example, the glasses assembly includes a first portion and a second portion opposite the first portion. The front cover defines a curve from the first portion to the second portion. The gap increases from the first portion to the second portion of the glasses assembly. The shroud is unitary and tapered from the first end to the second end. The core includes nylon and is bonded via an adhesive with the front cover at an angle greater than about 35 degrees and less than about 55 degrees. The core defining a length decreasing from the first portion to the second portion of the glasses assembly. The elastomer body defines a length increasing from the first portion to the second portion and defines a substantially flat contact surface at the second end. The contact surface is configured to contact the waveguide and the elastomer body is configured to flex in response to contacting the waveguide.

In one example, the core is stiffer than the elastomer body and the elastomer body at least partially surrounds the core and is configured to flex in response to contact with the waveguide at the second end. In one example, the elastomer body at least partially surrounds the core, the elastomer body defining a surface at the second end of the shroud that is substantially flat, the surface configured to contact the waveguide. The core includes a portion partially exposed at the first end of the shroud, the portion coupled with the front cover. In one example, the elastomer body at least partially surrounds the core, the core includes plastic, and the elastomer body includes silicon having a shore A hardness between about 50 and 90. In one example, the shroud is unitary and tapered from the first end to the second end. In one example, the shroud is defined by sections of elastomer bodies. In one example, the gap is greater than about 5 millimeters and less than about 25 millimeters.

In at least one example of the present disclosure, a glasses frame includes a first lens portion having a first outer side and a first inner side. The glasses frame includes a second lens portion having a second outer side and a second inner side. The glasses frame includes a front cover extending from the first outer side to the second outer side. The first lens portion includes a waveguide held by a suspension and extending between the first outer side and the first inner side. The front cover and the waveguide defining a gap that increases from the first outer side toward the first inner side. The first lens portion includes a shroud at least partially disposed in the gap and bonded with the front cover, the shroud extending with decreasing stiffness from the first outer side to the first inner side.

In one example, the front cover defines a curve from the first outer side to the second outer side, the shroud defines a first end and a second end, and the shroud defines an area between the first end and the second end. The area being non-uniform from the first outer side to the first inner side. In one example, the shroud is coupled with the front cover at an angle greater than about 35 degrees and less than about 55 degrees. In one example, the shroud includes an elastomer body and a core at least partially surrounded by the elastomer body and coupled with the front cover. The core defining a length decreasing from the first outer side to the first inner side. In one example, the shroud includes a core coupled with the front cover and an elastomer body at least partially surrounding the core. The elastomer body defining a length increasing from the first outer side to the first inner side. In one example, the gap at the first outer side is greater than about 5 millimeters and less than about 20 millimeters. The gap at the first inner side is greater than about 10 millimeters and less than about 25 millimeters. In one example, the shroud defines a first end and a second end and the second end defines a contact surface that is substantially flat and configured to contact the waveguide. The surface including a length greater than about 0.1 millimeters and less than about 2 millimeters.

In at least one example of the present disclosure, a glasses assembly includes a lens portion having an outer side and an inner side opposite the outer side, a front cover extending from the outer side towards the inner side. The lens portion includes a waveguide extending from the outer side to the inner side and a shroud disposed between the waveguide and the front cover, the shroud defining a first end and a second end. The shroud coupled with the front cover at the first end and extending with decreasing stiffness from the outer side to the inner side of the lens portion. The shroud includes a first material portion including a first material, and a second material portion including a second material different than the first material. The second material portion at least partially surrounding the first material portion.

In one example, the first material includes an elastomer and defines a body of the shroud, the second material includes a plastic and defines a core of the shroud, and the body at least partially surrounds the core and is configured to flex in response to contact with the waveguide at the second end. In one example, the core defines a first length. The first length decreasing from the outer side to the inner side. The body defines a second length. The second length increasing from the outer side to the inner side. In one example, the front cover and the waveguide define a gap that increases from the outer side to the inner side. The shroud at least partially disposed in the gap and defining a length increasing from the outer side to the inner side. In one example, the first material includes an electroactive polymer configured to receive a current. The shroud is directly coupled with the waveguide and the waveguide is configured to move in response to the shroud receiving the current.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective view of an example of a glasses assembly;

FIG. 2 shows an exploded view of an example of a glasses assembly including a shroud;

FIG. 3 shows an exploded view of an example of a glasses assembly including a shroud;

FIG. 4 shows an example of a shroud for a glasses assembly;

FIG. 5 shows a cross-sectional view of an example of a glasses assembly including a shroud;

FIG. 6 shows a cross-sectional view of an example of a glasses assembly including a shroud;

FIG. 7 shows a cross-sectional view of an example of a glasses assembly including a shroud;

FIG. 8 shows an exploded view of an example of a glasses assembly including a shroud;

FIG. 9A shows a cross-sectional view of an example of a glasses assembly including a shroud in a first position;

FIG. 9B shows a cross-sectional view of an example of a glasses assembly including a shroud in a second position; and

FIG. 9C shows a cross-sectional view of an example of a glasses assembly including a shroud in a third position.

### DETAILED DESCRIPTION

Detailed reference is provided below with regard to representative embodiments illustrated in the accompanying drawings. The following descriptions are not intended to limit the embodiments to one preferred embodiment. Rather, the following description are intended to cover alternatives, modifications, and equivalents as can be included within the spirit and scope of the described embodiments as defined by the appended claims.

The following disclosure relates to a glasses assembly. More particularly, the present disclosure relates to a waveguide bumper within a glasses assembly. Users can inadvertently bump, drop, or otherwise cause inadvertent contact between an electronic glasses device and another object or surface. For example, a user of the glasses assembly can drop the glasses assembly and in response to contacting a floor or similar surface, the components within the glasses assembly can contact each other.

Devices and systems of the present disclosure can reduce the impact force associated with the components of the glasses assembly contacting each other. During a free fall or other impact scenario, the various examples of the shroud described herein can absorb the impact force to reduce the force that is applied to the components of the device or assembly. In this way, the impact force applied to the components can be reduced sufficiently, thereby increasing durability.

In at least one example, a glasses assembly can include a front cover and a waveguide held by a suspension. The waveguide can project a virtual image. The waveguide can be a thin piece of glass. The front cover and the waveguide can define a gap. The glasses assembly can include a shroud at least partially disposed in the gap and defining a first end and a second end. The shroud and can include an elastomer body and a core coupled with the front cover at the first end of the shroud. Since the shroud can be at least partially disposed in the gap, the shroud can separate the front cover from the waveguide and can inhibit the front cover from contacting the waveguide in certain impact scenarios. For example, since the first end of the shroud is coupled with the front cover and the shroud has an elastomer body, the shroud can deform in response to an impact force, thereby at least partially absorbing the impact force and reducing the force applied to the waveguide. In this way, the shroud can be a bumper for the waveguide to protect the waveguide from unintended forces caused by the user during operation or manipulation.

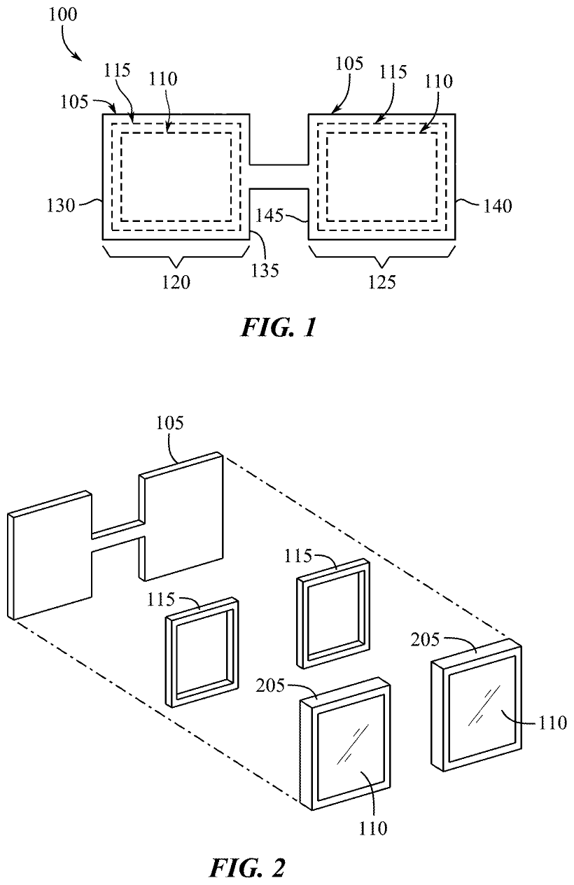

These and other embodiments are discussed below with reference to FIGS. 1-9C. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1 and 2 illustrate examples of a glasses assembly 100, for example a glasses frame 100, including various components such as structural elements. The glasses assembly 100 can be electric such that the glasses assembly 100 receives power from at least one rechargeable or non-rechargeable battery, an electrical outlet, or the like. The glasses assembly 100 can project digital information, such as images, onto at least one lens worn by a user. For example, the glasses assembly 100 can define at least one lens portion. The glasses assembly 100 can define a first portion 120, e.g., a first lens portion 120, with an outer side 130 and an inner side 135. The glasses assembly 100 can define a second portion 125, e.g., a second lens portion 125, with an outer side 140 and an inner side 145. The first and second portions 120, 125 can include the same components as each other as described herein. The second portion 125 can be opposite the first portion 120.

As used herein, the terms “inner” and “outer” can refer to edges, sides, or features of the glasses assembly 100 positioned next to or away from certain facial features of a user when the glasses assembly 100 is donned. For example, the inner sides 135, 145 can be configured to rest or be disposed adjacent a user's nose when the assembly 100 is donned while the outer sides 130, 140 can rest or be disposed away from the user's nose. The inner sides 135, 145 can be disposed between the opposing outer sides 130, 140 as shown in FIG. 1.

As used herein, the terms “structural,” “structure,” “structurally,” and related terms refer to load bearing components and elements, or components and elements contributing to the physical form of an object, such as a glasses assembly. For example, the frame of a glasses assembly can be formed of various structural elements adding to the form and shape of the glasses assembly, and the lenses can include various structural elements adding to the form and shape of the glasses assembly including load bearing elements such as load bearing structural suspension mechanisms and the like.

The glasses assembly 100 can include a front cover 105. The front cover 105 can be or can include suitable materials such as glass, plastic, metal, composite materials or the like. For example, the front cover 105 can include a clear or otherwise transparent plastic. The front cover 105 can be or can include a material that is substantially non-elastic. For example, with a force applied to the front cover 105, the shape of the front cover 105 can remain substantially unchanged, or otherwise not flex in response to force anticipated during normal use. The front cover 105 can include material that is lightweight, e.g., cellulose acetate propionate, zylonite, nylon, or the like. The front cover 105 can be or can include an external surface of the glasses assembly 100, e.g., the external surface of the front cover 105 can be a front face of the glasses assembly 100. For example, the front cover 105 can at least partially encase the various components of the glasses assembly 100.

The front cover 105 can extend across the width of the glasses assembly 100, e.g., from a first portion to a second portion of the glasses assembly 100. The front cover 105 can extend continuously. For example, the front cover 105 can extend from the outer side 130 of the first lens portion 120 to the outer side 140 of the second lens portion 125. In this example, the front cover 105 can be greater than or equal to about 8 centimeters and less than or equal to about 20 centimeters. The front cover 105 can extend in segments. For example, a first segment of the front cover 105 can extend from the outer side 130 of the first lens portion 120 to the inner side 135 of the first lens portion 120, and a second segment of the front cover 105 can extend from the inner side 145 of the second lens portion 125 to the outer side 140 of the second lens portion 125. In this example, the segments of the front cover 105 can be greater than or equal to about 4 centimeters and less than or equal to about 10 centimeters.

The glasses assembly 100 can include at least one waveguide 110. For example, the first lens portion 120 and the second lens portion 125 can each include a waveguide 110. The waveguide 110 can be a reflective waveguide, polarized waveguide, diffractive waveguide, holographic waveguide, or the like. The waveguide 110 can be or can include glass, plastic, or other suitable materials. For example, the waveguide 110 can include a clear or otherwise transparent glass such as a glass substrate. The waveguide 110 can define a thickness greater than or equal to about 0.05 nanometers and less than or equal to about 3 nanometers. The waveguide 110 can include an anti-reflective coating, protective coating, or the like.

The waveguide 110 can extend across the glasses assembly 100, e.g., a portion of the glasses assembly 100. A first waveguide 110 can extend at least partially across the first lens portion 120 of the glasses assembly 100 and a second waveguide 110 can extend at least partially across the second lens portion 125 of the glasses assembly 100. For example, the first waveguide 110 can extend from about the outer side 130 to about the inner side 135 of the first lens portion 120, and the second waveguide 110 can extend from about the inner side 145 to about the outer side 140 of the second lens portion 125. In another example, the waveguide 110 can extend continuously across the glasses assembly 100, e.g., from about the outer side 130 of the first lens portion 120 to about the outer side 140 of the second lens portion 125.

The waveguide 110 can project a virtual image. For example, the waveguide 110 can include multiple layers of glass substrates to project the virtual image. The layers of the waveguide 110 can transmit at least one portion of the light wavelength spectrum, e.g., red, green, blue, as so on. The waveguide 110 can project the virtual image on a lens of the glasses assembly 100, e.g., a lens of the first lens portion 120 and a lens of the second lens portion 125.

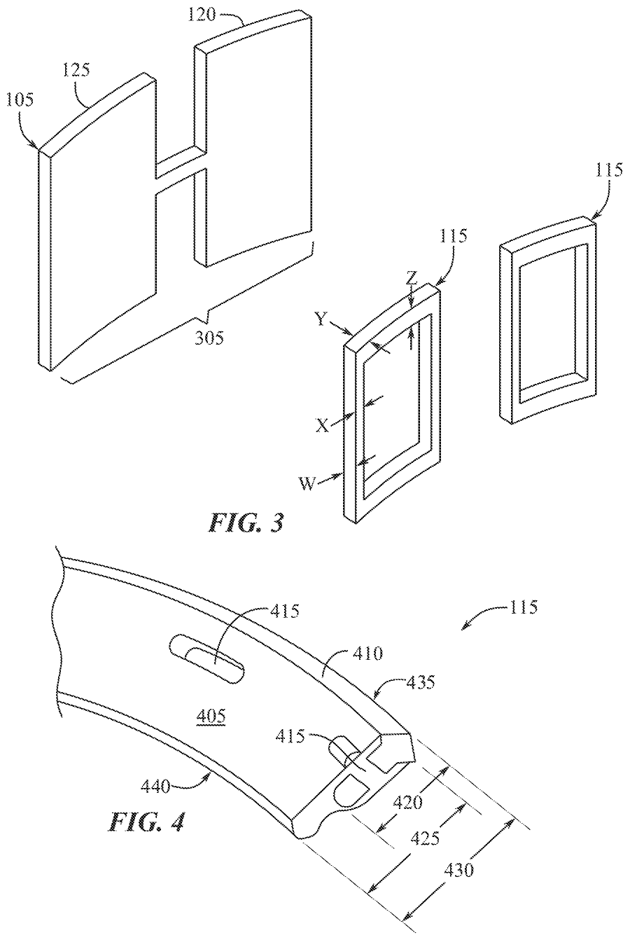

In at least one example, as shown in FIG. 3, the waveguide 110 can be held by a suspension 205. For example, the waveguide 110 can be bound to the suspension 205 via an adhesive. The suspension 205 can be or can include metal, plastic, or the like. For example, the suspension 205 can include sheet metal. The suspension 205 can at least partially protect the waveguide 110 in an impact scenario, e.g., a scenario with a force applied to the glasses assembly 100. For example, the suspension 205 can at least partially protect the waveguide 110 with a force applied to a side portion, such as an arm or a strap, of the glasses assembly 100. The suspension 205 can include a spring, such as a leaf spring, to at least partially absorb the force applied to the glasses assembly 100.

The glasses assembly 100 can include at least one shroud 115. For example, the first lens portion 120 and the second lens portion 125 can each include a shroud 115. The shroud 115 can be unitary, e.g., a unitary structure. In this example, the shroud 115 can be a continuous shape, such as a square, rectangle, circle, irregular shape, or the like. In some examples, the shroud 115 can include a shape corresponding to a shape of the waveguide 110. The shroud 115 can include at least one material. For example, the shroud 115 can include a flexible material that can deform in response to a force applied to the shroud 115. The stiffness of the shroud 115 can be variable. For example, a portion of the shroud 115 can be stiffer than another portion of the shroud 115.

The shroud 115 can extend across the glasses assembly 100, e.g., a portion of the glasses assembly 100. A first shroud 115 can extend at least partially across the first lens portion 120 of the glasses assembly 100 and a second shroud 115 can extend at least partially across the second lens portion 125 of the glasses assembly 100. For example, the first shroud 115 can extend from about the outer side 130 to about the inner side 135 of the first lens portion 120, and the second shroud 115 can extend from about the inner side 145 to about the outer side 140 of the second lens portion 125. In this example, the shrouds 115 can each extend across the first lens portion 120 and the second lens portion 125, respectively, with decreasing stiffness. For example, the shroud 115 can extend with decreasing stiffness from the outer side 130 to the inner side 135 of the first lens portion 120. In another example, the shroud 115 can extend continuously across the glasses assembly 100, e.g., from about the outer side 130 of the first lens portion 120 to about the outer side 140 of the second lens portion 125.

The shroud 115 can be disposed between the front cover 105 and the waveguide 110. The shroud 115 can contact at least one of the front cover 105, the waveguide 110, or another component of the glasses assembly 100. For example, the shroud 115 can be coupled with the front cover 105, or another component of the glasses assembly 100, without contacting the waveguide 110. The shroud 115 can be bonded with the front cover 105 or another component of the glasses assembly 100, e.g., via an adhesive, or can be an integral part of the front cover 105, e.g., an over-molded perimeter of the inside surface of the front cover 105. In another example, the shroud 115 can be coupled with the front cover 105, or another component of the glasses assembly 100, and in contact with the waveguide 110 in response to a force applied to the glasses assembly 100. In this example, the shroud 115 can at least partially protect the waveguide 110 in an impact scenario, e.g., a scenario with a force applied to the glasses assembly 100. For example, the shroud 115 can at least partially protect the waveguide 110 with a force applied to a front portion, such as the front cover 105, of the glasses assembly 100. Since the shroud 115 can include a flexible material that can deform in response to a force applied to the shroud 115, the shroud 115 can at least partially absorb the force applied to the front cover 105, which can reduce the magnitude of the force applied to the waveguide 110. In this way, the shroud 115 can be or can include a waveguide bumper. In this example, the shroud 115 can at least partially protect the waveguide 110 with a force applied the front cover 105, and the suspension 205 can at least partially protect the waveguide 110 with a force applied to an arm or a strap of the glasses assembly 100.

Any of the features, components, and/or parts, including the arrangements and configurations thereof shown in FIGS. 1 and 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1 and 2.

FIG. 3 illustrates an example of the glasses assembly 100 including the shroud 115. The front cover 105 can define a curve 305. For example, the front cover 105 can be curved to accommodate or follow the contours and curve of a user's face. The front cover 105 can define the curve 305 from the first portion 120 to the second portion 125 of the glasses assembly 100. The front cover 105 can define the curve 305 from the outer side 130 of the first lens portion 120 to the outer side 140 of the second lens portion 125. Since the front cover 105 can define the curve 305, the other components of the glasses assembly 100 at least partially encased by the front cover 105 can also define curves to correspond with the curve 305. For example, at least one of the shroud 115, the waveguide 110, and the like can be curved. In another example, the front cover 105 can be straight, e.g., from the first portion 120 to the second portion 125 of the glasses assembly 100.

The shroud 115 can define at least one area, e.g., at least one surface area and volumetric area. The various areas of the shroud 115 can be not uniform. For example, the areas can be not uniform from the outer side 130 to the inner side 135 of the first lens portion 120. In this example, thicknesses W, X, Y, and Z of the shroud 115 can vary. The thicknesses Y and Z can vary from the outer side 140 to the inner side 145 of the second lens portion 125. Additionally, the thicknesses W and X can vary from the outer side 140 to the inner side 145 of the second lens portion 125. For example, the thicknesses W and X can increase from the outer side 140 to the inner side 145 of the second lens portion 125, e.g., the thicknesses W and X can each be larger at the inner side 145 than the thicknesses W and X at the outer side 140. Although the thicknesses W, X, Y, and Z of the shroud 115 are shown in FIG. 3 corresponding to the second lens portion 125 of the glasses assembly 100, the shroud 115 corresponding to the first lens portion 120 can define the same thicknesses W, X, Y, and Z. For example, the thicknesses W and X can increase from the outer side 130 to the inner side 135 of the first lens portion 120.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

FIG. 4 illustrates an example of the shroud 115 for the glasses assembly 100. The shroud 115 can include at least one material, e.g., a first material portion 405 and a second material portion 410. The shroud 115 can include at least one mechanical interlock 415. The mechanical interlock 415 can be disposed at the second material portion 410 and throughout the first material portion 405.

The first material portion 405 can be or can include a material that is elastically flexible, such as an elastomer. As described herein, “elastic” or “flexible” materials or portions are those that elastically deform under forces anticipated during normal and/or expected use. For example, the first material portion 405 can be one or more of silicon, natural rubber, styrene-butadiene block copolymers, polyisoprene, nitrile rubbers, or the like. The first material portion 405 can define a body of the shroud 115. For example, the first material portion 405 can be referred to as, or can include, an elastomer body 405 of the shroud 115. The elastomer body 405 can include silicon, or a similar flexible material. The overall hardness of the shroud 115 can be tuned in response to tuning the first material portion 405. In other words, the elastic response of the first material portion 405 can be tuned. On a shore hardness scale, the hardness of the elastomer body 405 can be greater than or equal to about 50 shore A and less than or equal to about 90 shore A in order to function as described herein, for example between about 60 shore A and about 80 shore A. For example, the elastomer body 405 can include 70 shore A hardness silicon.

The second material portion 410 can be or can include a material that is hard, e.g., a material that is stiffer than the first material portion 405, such as a plastic. As referred to herein, “hard” or “plastic” materials can include materials that are not meant to elastically deform or flex noticeably or non-negligibly during normal and/or expected use. For example, the second material portion 410 can be a bonding plastic such as Nylon, Acrylonitrile Butadiene Styrene (ABS), Polyvinyl Chloride (PVC), Acrylic, Polycarbonate, and the like. The second material portion 410 can define a core 410 of the shroud 115. For example, the second material portion 410 can be or can include the core 410 of the shroud 115. The core 410 of the shroud 115 can include Nylon, or a similar hard material or plastic.

The elastomer body 405 can at least partially surround the core 410. In other words, the core 410 can at least partially be surrounded by the elastomer body 405. In this way, the core 410 can structurally support the elastomer body 405, and thus the shroud 115. For example, the elastomer body 405 can be flexible and deform or otherwise deflect in response to a force applied to the shroud 115. However, since the core 410 is stiffer than the elastomer body 405, the core 410 can flex less than the elastomer body 405 or not at all in response to the force applied to the shroud 115. In this way, the shroud 115 can at least partially flex in response to the force applied to the shroud 115, but not completely flex or deform, due to the stiffness of the core 410.

The shroud 115 can define a first end 435 and a second end 440. The distance between the first end 435 and the second end 440 can be the thickness W, as depicted in FIG. 3. Additionally, the shroud 115 can define a length 430 from the first end 435 to the second end 440 of the shroud 115. The shroud 115 can be tapered from the first end 435 to the second end 440. In other words, the thickness W of the shroud 115 can reduce. The thickness W of the shroud 115 can be tapered or otherwise reduced across the length 430 from the surface adjacent the front cover 105 to the surface adjacent the waveguide 110.

The core 410 can define a length 420 from the first end 435 of the shroud 115. The elastomer body 405 can define a length 425 from the first end 435 of the shroud 115. The lengths 420, 425 can be variable across the shroud 115. For example, the lengths 420, 425 can increase or decrease from the outer side 130 of the first lens portion 120 to the outer side 140 of the second lens portion 125. The length 430 of the shroud 115 can increase from the outer side 130 to the inner side 135 of the first lens portion 120 and can increase from the outer side 140 to the inner side 145 of the second lens portion 125. As discussed in more detail below, the length 420 of the core 410 can decrease from the outer side 130 to the inner side 135 of the first lens portion 120 and can decrease from the outer side 140 to the inner side 145 of the second lens portion 125. In this way, the shroud 115 can decrease in stiffness from the outer side 130 to the inner side 135 of the first lens portion 120 and from the outer side 140 to the inner side 145 of the second lens portion 125. The length 425 of the elastomer body 405 can increase from the outer side 130 to the inner side 135 of the first lens portion 120 and can increase from the outer side 140 to the inner side 145 of the second lens portion 125. In this way, the shroud 115 can increase in flexibility from the outer side 130 to the inner side 135 of the first lens portion 120 and from the outer side 140 to the inner side 145 of the second lens portion 125.

In another example, the first material portion 405 and the second material portion 410 can be the same material. For example, the decreasing stiffness of the shroud 115 can also be achieved by only varying the thickness of the shroud 115, such that only one material is used. For example, the shroud 115 can include only one material, such as a black plastic that decreases in stiffness from the first end 435 to the second end 440 of the shroud 115, from the outer side 130 to the inner side 135 of the first lens portion 120, and from the outer side 140 to the inner side 145 of the second lens portion 125. In another example, the materials 405, 410 can both be an electroactive polymer. In this example, the shroud 115 can be coupled, e.g., directly, with the waveguide 110. The materials 405, 410 can receive a current to move the waveguide 110 in response to the shroud 115 receiving the current. For example, the position and angle of the waveguide 110 can change in response to the current.

Any of the features, components, and/or parts, including the arrangements and configurations thereof shown in FIG. 4 can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

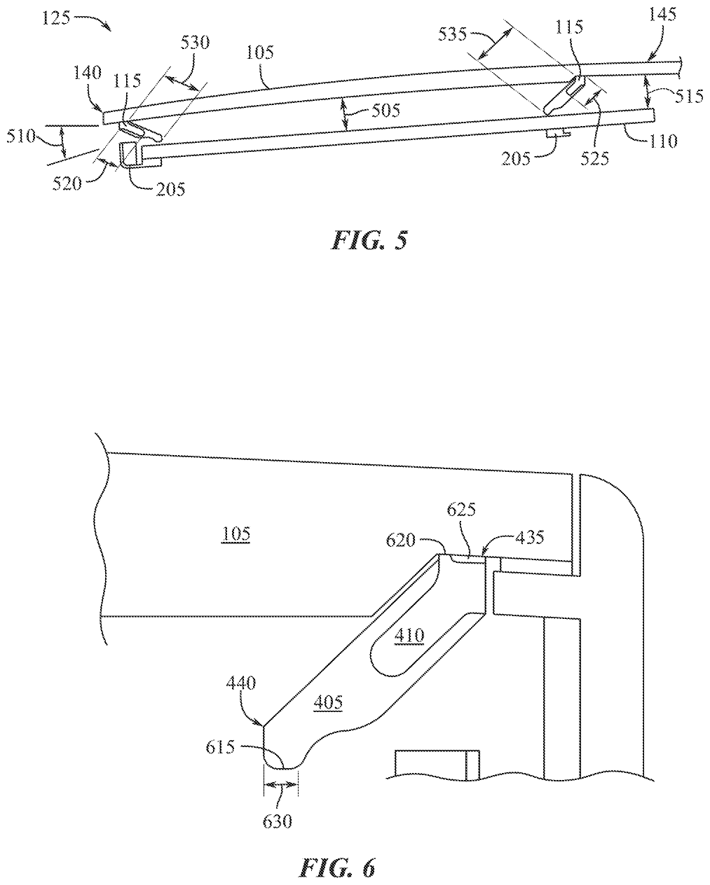

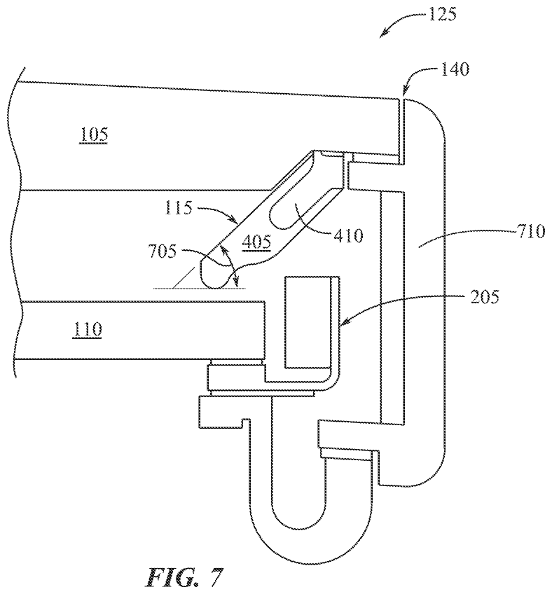

FIGS. 5-7 illustrate examples of the glasses assembly 100 including the shroud 115. The front cover 105 and the waveguide 110 can be spaced apart to define a gap 505, as depicted in FIG. 5. For example, the gap 505 can be between the front cover 105 and the waveguide 110. The gap 505 can be a length greater than or equal to about 5 millimeters and less than or equal to about 25 millimeters. For example, the gap 505 between the front cover 105 and the waveguide 110 can be about 15 millimeters. The front cover 105 and the waveguide 110 can be coupled, e.g., indirectly coupled. For example, structural components 710 of the glasses assembly 100 can indirectly couple the front cover 105 with the suspension 205 and thus the waveguide 110, as depicted in FIG. 7. In this way, the gap 505 can be defined by the structural components 710, the front cover 105, and the waveguide 110.

The gap 505 can vary. For example, the gap 505 can increase or decrease across the glasses assembly 100. The gap 505 can increase from the first portion 120 to the second portion 125 of the glasses assembly 100, and vice versa. For example, the gap 505 can increase from the outer side 130 of the first lens portion 120 to the inner side 135 of the first lens portion 125 and the inner side 145 of the second lens portion 125, and the gap 505 can increase from the outer side 140 of the second lens portion 125 to the inner side 135 of the first lens portion 125 and the inner side 145 of the second lens portion 125. In another example, the gap 505 can decrease from the inner side 135 of the first lens portion 120 and the inner side 145 of the second lens portion 125 to the outer side 130 of the first lens portion 120 and the outer side 140 of the second lens portion 125, respectively.

In this example, a length 515 of the gap 505 at the inner sides 135, 145 can be greater than a length 510 of the gap 505 at the outer sides 130, 140. In other words, the length 510 of the gap 505 at the outer sides 130, 140 can be less than the length 515 of the gap 505 at the inner sides 135, 145. The gap 505 can be about equal at the inner side 135 of the first lens portion 125 and the inner side 145 of the second lens portion 125. The gap 505 can be about equal at the outer side 130 of the first lens portion 125 and the outer side 140 of the second lens portion 125. The length 510 of the gap 505 at the outer sides 130, 140 can be greater than or equal to about 5 millimeters and less than or equal to about 20 millimeters. For example, the gap 505 at the outer side 130 of the first lens portion 120 can be greater than about 10 millimeters and less than about 15 millimeters. The length 515 of the gap 505 at the inner sides 135, 145 can be greater than or equal to about 10 millimeters and less than or equal to about 25 millimeters. For example, the gap 505 at the inner side 135 of the first lens portion 120 can be greater than or equal to about 15 millimeters and less than or equal to about 20 millimeters.

The shroud 115 can be at least partially disposed in the gap 505. For example, the shroud 115 can be disposed between the front cover 105 and the waveguide 110. The core 410 can include or define a portion 620 partially exposed, e.g., not surrounded by or otherwise in contact with the elastomer body 405. The portion 620 can be defined at the first end 435 of the shroud 115. The portion 620 can be coupled with the front cover 105. For example, the core 410 can be coupled with the front cover 105 at the first end 435 of the shroud 115. The portion 620 of the core 410 can be coupled with or otherwise bonded to the front cover 105 via an adhesive 625, as depicted in FIG. 6. The adhesive 625 can be an industrial adhesive including ABP 8520E2, ABP 8035M, and ABP 2032S, or the like. In another example, the shroud 115 can be an integral part of the front cover 105 such that the shroud 115 is an over-molded perimeter of the inside surface of the front cover 105. In order to protect the front cover 105 and waveguide 110 as described herein, the shroud 115 can be coupled with, e.g., at the core 410, or otherwise extend from the front cover 105 at an angle 705 greater than or equal to about 35 degrees and less than or equal to about 55 degrees, as depicted in FIG. 7. For example, the angle 705 can be about 45 degrees.

In the example with the length 510 of the gap 505 at the outer sides 130, 140 less than the length 515 of the gap 505 at the inner sides 135, 145, the stiffness of the shroud 115 can be greater at the outer sides 130, 140 than the stiffness of the shroud 115 at the inner sides 135, 145. In the example, with the stiffness of the shroud 115 greater at the outer sides 130, 140 than at the inner sides 135, 145, the shroud 115 can prevent or otherwise inhibit the waveguide 110 from swinging at either of the inner sides 135, 145 or the outer sides 130, 140 in response to a force applied to the glasses assembly 100. In other words, the stiffness of the shroud 115 can compensate for the varying length of the gap 505 so as to provide a substantially uniform rate of compression of the shroud 115 towards the waveguide 110 via varying rates of deformation of the shroud 115. For example, the shroud 115 at the outer sides 130, 140 can deform at a slower rate than the shroud 115 at the inner sides 135, 145 due to the greater stiffness of the shroud 115 at the outer sides 130, 140 than at the inner sides 135, 145.

The length 420 of the core 410 can vary, thus varying the stiffness of the shroud 115. The core 410 can define the length 420 decreasing from the first portion 120 towards the second portion 125 of the glasses assembly 100, and vice versa. For example, the length 420 can decrease from the outer side 130 of the first lens portion 120 to the inner side 135 of the first lens portion 125, and the gap 505 can decrease from the outer side 140 of the second lens portion 125 to the inner side 145 of the second lens portion 125. In this example, a length 525 of the core 410 at the inner sides 135, 145 can be less than a length 520 of the core 410 at the outer sides 130, 140. In other words, the length 520 of the core 410 at the outer sides 130, 140 can be greater than the length 525 of the core 410 at the inner sides 135, 145. In this example, the shroud 115 can be stiffer at the outer sides 130, 140 than at the inner sides 135, 145.

The length 425 of the elastomer body 405 can vary, thus varying the stiffness of the shroud 115. The elastomer body 405 can define the length 425 increasing from the first portion 120 towards the second portion 125 of the glasses assembly 100, and vice versa. For example, the length 425 can increase from the outer side 130 of the first lens portion 120 to the inner side 135 of the first lens portion 125, and the gap 505 can increase from the outer side 140 of the second lens portion 125 to the inner side 145 of the second lens portion 125. In this example, a length 535 of the elastomer body 405 at the inner sides 135, 145 can be greater than a length 530 of the elastomer body 405 at the outer sides 130, 140. In other words, the length 530 of the elastomer body 405 at the outer sides 130, 140 can be less than the length 535 of the elastomer body 405 at the inner sides 135, 145. In this example, the shroud 115 can be stiffer at the outer sides 130, 140 than at the inner sides 135, 145.

The shroud 115 can define a surface 615 or a contact surface 615, as depicted in FIG. 6. The surface 615 can be defined at the second end 440 of the shroud 115. In this example, the surface 615 can contact the waveguide 110, e.g., with a force applied to the glasses assembly 100. The surface 615 can be substantially flat. For example, the surface 615 can be substantially flat so as to prevent or otherwise inhibit a point load from being applied to the waveguide 110 by the shroud 115. With the surface 615 substantially flat, the force resulting in response to the contact between the shroud 115 and the waveguide 110 can be distributed and the shroud 115 can be prevented or otherwise inhibited from buckling. The surface 615 can include or define a length 630. The length 630 can be greater than or equal to about 0.1 millimeters and less than or equal to about 2 millimeters. For example, the length 630 can be about 1 millimeter.

Any of the features, components, and/or parts, including the arrangements and configurations thereof shown in FIGS. 5-7 can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 5-7.

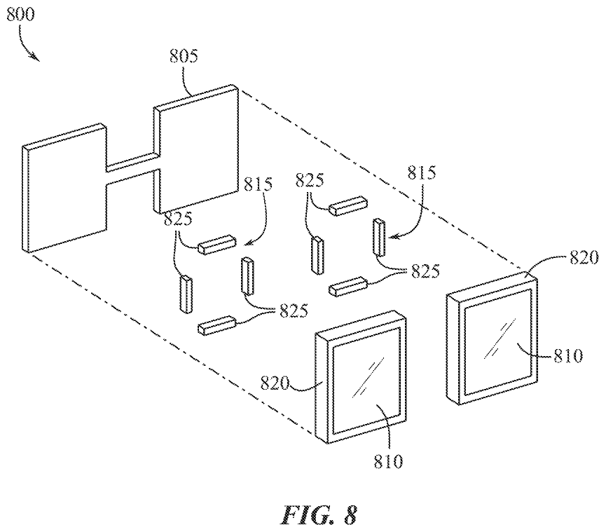

FIG. 8 illustrates an example of a glasses assembly 800 including a shroud 815. The glasses assembly 800 can be similar to the glasses assembly 100. For example, the glasses assembly 800 can include a front cover 805 and a waveguide 810. The waveguide 810 can be held by a suspension 820. The front cover 805, the waveguide 810, and the suspension 820 can be similar to or the same as the front cover 105, the waveguide 110, and the suspension 205, respectively. For example, the front cover 805, the waveguide 810, and the suspension 820 can define or include the same dimensions and materials as the front cover 105, the waveguide 110, and the suspension 205, respectively. Additionally, components of the glasses assembly 800 can be coupled or otherwise in contact with each other similarly to or the same as the components of the glasses assembly 100.

The shroud 815 can be similar to or the same as the shroud 115. For example, the shroud 815 can include or define the same materials and dimensions as the shroud 115. The shroud 815 can be defined by sections of elastomer bodies 825. In this example, the shroud 815 can be non-unitary, e.g., a non-unitary structure. For example, the shroud 815 can be a non-continuous shape, such as a broken square, rectangle, circle, or the like. FIG. 8 depicts the shroud 815 as a broken square. For example, the sections of elastomer bodies 825 can at least partially define a square shape, e.g., the sections of elastomer bodies 825 can define edges of a square, as depicted in FIG. 8, corners of a square, or combinations of both. The sections of elastomer bodies 825 can align with the front cover 805 and the waveguide 110 held by the suspension 820. For example, the non-continuous shape of the shroud 815 can correspond with the shape of the front cover 805, the waveguide 110, or both.

The shroud 815 can be similar to or the same as the shroud 115. For example, the shroud 815 can be coupled with the front cover 805 or other components of the glasses assembly 800, e.g., via an adhesive. The shroud 815 can include at least one core similar to or the same as the core 410. Each of the sections of elastomer bodies 825 can at least partially surround a core and each core can be bonded or otherwise coupled with the front cover 805. Each of the sections of elastomer bodies 825 and cores can be of varying stiffness. For example, the stiffness of each of the sections of elastomer bodies 825 and cores can vary and the average stiffness of each section of elastomer body 825 can vary with respect to each other. In another example, the stiffness of each of the sections of elastomer bodies 825 can be uniform, but the stiffness can vary with respect to each other.

In these examples, the stiffness of the section of elastomer body 825 at the outer side of the glasses assembly 800 can be stiffer than the section of elastomer body 825 at the inner side of the glasses assembly 800. In this way, the shroud 815 can prevent or otherwise inhibit the waveguide 810 from swinging at either side of the glasses assembly 800 in response to a force applied to the glasses assembly 800. In other words, the varying stiffness of the shroud 815 can provide a substantially uniform rate of compression of the shroud 815 towards the waveguide 810 via varying rates of deformation of the sections of elastomer bodies 825. For example, the shroud 815 at the outer sides of the glasses assembly 800 can deform at a slower rate than the shroud 815 at the inner sides of the glasses assembly 800 due to the greater stiffness of the shroud 815 at the outer sides than at the inner sides.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, cither alone or in any combination, in the example of the devices, features, components, and parts shown in FIG. 8.

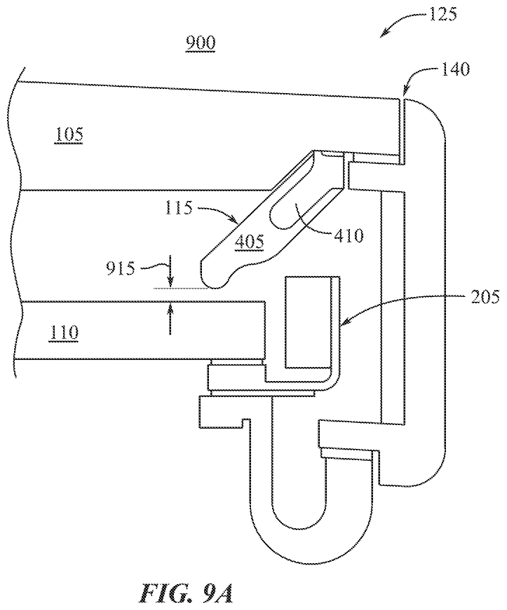

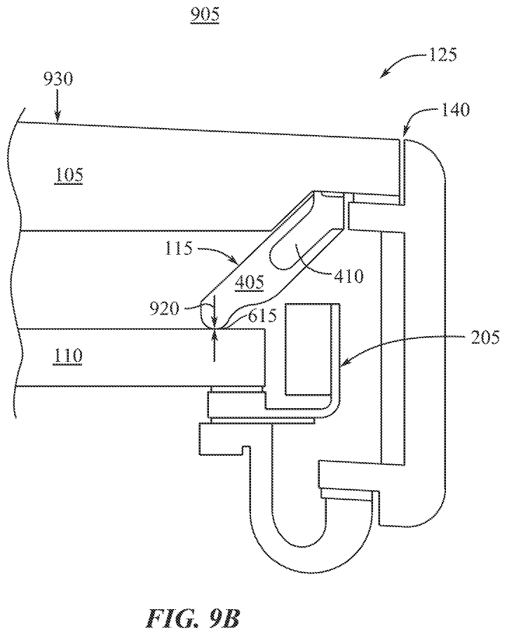

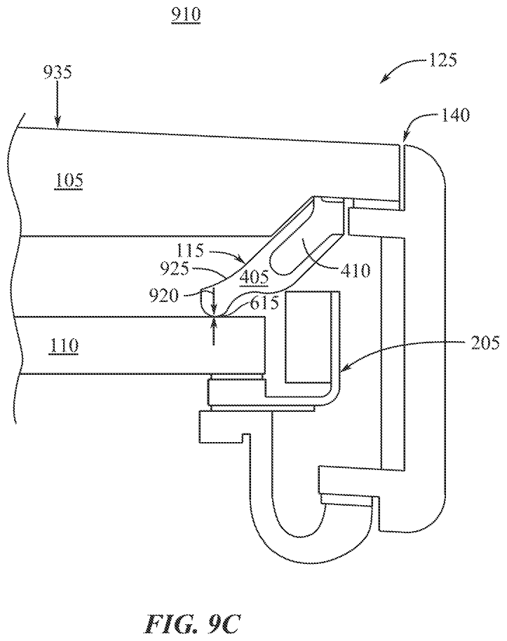

FIGS. 9A-9C illustrate examples of the glasses assembly 100 including the shroud 115 in various positions. FIG. 9A illustrates the shroud 115 in a first position 900. FIG. 9B illustrates the shroud 115 in a second position 905. FIG. 9C illustrates the shroud 115 in a third position 910.

With the shroud 115 in the first position 900, the shroud 115 and the waveguide 110 can define a gap 915. For example, the shroud 115 and the waveguide 110 can be isolated from each other or otherwise not in direct contact. The gap 915 can be greater than or equal to about 40 microns and less than or equal to about 60 microns. For example, the gap 915 can be about 50 microns. In the first position 900, the waveguide 110 can be in contact with only the suspension 205. With the shroud 115 in the first position 900, the glasses assembly 100 can be at least partially in a state of equilibrium. For example, a force may not be applied to the glasses assembly 100, e.g., at the front cover 105. In this example, a force can be applied to the glasses assembly 100 at a location other than the front cover 105 or similarly located surface.

The shroud 115 can transition from the first position 900 to the second position 905 in response to a force 930 applied to the glasses assembly 100. For example, the force 930 can be applied at the front cover 105, as depicted in FIG. 9B. The shroud 115 can transition from the second position 905 to the first position 900 in response to the magnitude of the force 930 decreasing or with the force 930 otherwise removed from the glasses assembly 100.

With the shroud 115 in the second position 905 shown in FIG. 9B, the shroud 115 and the waveguide 110 can define a gap 920. The gap 920 can be less than the gap 915. For example, the gap 920 can be greater than or equal to about 0 microns and less than about 60 microns. In the second position 905, the shroud 115, e.g., the surface 615, can contact the waveguide 110. The force 930 can have a magnitude sufficient to compress the front cover 105 and the shroud 115 towards the waveguide 110.

The shroud 115 can transition from the second position 905 to the third position 910 in response to a force 935 applied to the glasses assembly 100. For example, the force 935 can be applied at the front cover 105, as depicted in FIG. 9C. The shroud 115 can transition from the third position 910 to the second position 905 in response to the magnitude of the force 935 decreasing or the force 935 otherwise removed from the glasses assembly 100.

With the shroud 115 in the third position 910 shown in FIG. 9C, the shroud 115 and the waveguide 110 can define the gap 920. For example, the length of the gap 920 can be 0 microns with the shroud 115 in the third position 910. In the third position 910, the shroud 115, e.g., the surface 615, can contact the waveguide 110. The force 935 can have magnitude larger than the magnitude of the force 930. The magnitude of the force 935 can be sufficient to compress the front cover 105 and the shroud 115 towards the waveguide 110 as well as flex, compress, or otherwise deform the shroud 115. In this example, the shroud 115 can define a flexed surface 925 of the shroud 115. For example, the elastomer body 405 can flex in response to contact with the waveguide 110 at the second end 440 of the shroud 115. The flexed surface 925 can include or define a concave curvature. For example, the second end 440 of the shroud 115 can compress towards the front cover 105. The shroud 115 can remain substantially straight along the length 420 of the core 410, since the core 410 is stiffer than the elastomer body 405, and the shroud 115 can flex along the length 425 of the elastomer body 405, since the elastomer body 405 can be or can include a flexible material.

With the shroud 115 defining the flexed surface 925, the shroud 115 can at least partially absorb the force 935, thereby reducing the magnitude of the force 935 that is transferred or otherwise applied to the waveguide 110. For example, with the glasses assembly 100 not including the shroud 115, the front cover 105 can directly contact the waveguide 110. In this example and since the front cover 105 can be or can include a non-clastic material, about the entire magnitude of the force 935 can be transferred to the waveguide 110.

Any of the features, components, and/or parts, including the arrangements and configurations thereof shown in FIGS. 9A-9C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 9A-9C.

The terms “about” and “substantially” herein are to be construed as +/−10%, unless stated otherwise. Every range of values (of the form, “from about a to about b,” or, equivalently, “from approximately a to b,” or, equivalently, “from approximately a-b” or, equivalently, “greater than about a and less than about b”) disclosed herein is to be understood to set forth every number and range encompassed within the broader range of values.

In some examples, the present system can gather user specific information to provide a customized experience for the user. In such examples, the collection, storage, use and transmission of the user specific data should be conducted in accordance with well-known and accepted data privacy standards.

The specific details provided above are not required in order to practice the described examples and are presented for purposes of illustration and description. The details provided above are not exhaustive and should not limit the embodiments to the precise forms disclosed. Rather, many modifications and variations are possible in view of the above teachings.

What is claimed is:

1. A glasses assembly, comprising:
a front cover;
a suspension;
a waveguide held by the suspension, the front cover and the waveguide defining a gap; and
a shroud at least partially disposed in the gap and defining a first end and a second end, the shroud comprising:
an elastomer body; and
a core coupled with the front cover at the first end of the shroud.

2. The glasses assembly of claim 1, wherein:
the glasses assembly comprises a first portion and a second portion opposite the first portion;
the front cover defines a curve from the first portion to the second portion;
the gap increases from the first portion to the second portion of the glasses assembly;
the shroud is unitary and tapered from the first end to the second end;
the core comprises nylon and is bonded via an adhesive with the front cover at an angle greater than about 35 degrees and less than about 55 degrees, the core defining a length decreasing from the first portion towards the second portion of the glasses assembly; and
the elastomer body defines a length increasing from the first portion towards the second portion and defines a substantially flat surface at the second end, the substantially flat surface is configured to contact the waveguide and the elastomer body is configured to flex in response to contacting the waveguide.

3. The glasses assembly of claim 1, wherein:
the core is stiffer than the elastomer body; and
the elastomer body at least partially surrounds the core and is configured to flex in response to contact with the waveguide at the second end.

4. The glasses assembly of claim 1, wherein:
the elastomer body at least partially surrounds the core, the elastomer body defining a contact surface at the second end of the shroud that is substantially flat; and
the core includes a portion partially exposed at the first end of the shroud, the portion coupled with the front cover.

5. The glasses assembly of claim 1, wherein:
the elastomer body at least partially surrounds the core;
the core comprises plastic; and
the elastomer body comprises silicon having a shore A hardness between about 50 and 90.

6. The glasses assembly of claim 1, wherein the shroud is unitary and tapered from the first end to the second end.

7. The glasses assembly of claim 1, wherein the shroud is defined by sections of elastomer bodies.

8. The glasses assembly of claim 1, wherein the gap is greater than about 5 millimeters and less than about 25 millimeters.

9. A glasses frame, comprising:
a first lens portion having a first outer side and a first inner side;
a second lens portion having a second outer side and a second inner side; and
a front cover extending from the first outer side to the second outer side;
wherein the first lens portion comprises:
a waveguide held by a suspension and extending between the first outer side and the first inner side, the front cover and the waveguide defining a gap that increases from the first outer side toward the first inner side; and
a shroud at least partially disposed in the gap and bonded with the front cover, the shroud extending with decreasing stiffness from the first outer side to the first inner side.

10. The glasses frame of claim 9, wherein:
the front cover defines a curve from the first outer side to the second outer side;
the shroud defines a first end and a second end; and
the shroud defines an area between the first end and the second end, the area being non-uniform from the first outer side to the first inner side.

11. The glasses frame of claim 9, wherein the shroud is coupled with the front cover at an angle greater than about 35 degrees and less than about 55 degrees.

12. The glasses frame of claim 9, wherein the shroud comprises:
an elastomer body; and
a core at least partially surrounded by the elastomer body and coupled with the front cover, the core defining a length decreasing from the first outer side to the first inner side.

13. The glasses frame of claim 9, wherein the shroud comprises:
a core coupled with the front cover; and
an elastomer body at least partially surrounding the core, the elastomer body defining a length increasing from the first outer side to the first inner side.

14. The glasses frame of claim 9, wherein:
the gap at the first outer side is greater than about 5 millimeters and less than about 20 millimeters; and
the gap at the first inner side is greater than about 10 millimeters and less than about 25 millimeters.

15. The glasses frame of claim 9, wherein:
the shroud defines a first end and a second end; and
the second end defines a contact surface that is substantially flat, the contact surface including a length greater than about 0.1 millimeters and less than about 2 millimeters.

16. A glasses assembly, comprising:
a lens portion having an outer side and an inner side opposite the outer side;
a front cover extending from the outer side towards the inner side;
wherein the lens portion comprises:
a waveguide extending from the outer side to the inner side;
a shroud disposed between the waveguide and the front cover, the shroud defining a first end and a second end, the shroud coupled with the front cover at the first end and extending with decreasing stiffness from the outer side to the inner side of the lens portion, the shroud comprising:
a first material portion including a first material; and
a second material portion including a second material different than the first material, the first material portion at least partially surrounding the second material portion.

17. The glasses assembly of claim 16, wherein:
the first material comprises an elastomer and defines a body of the shroud;
the second material comprises a plastic and defines a core of the shroud; and
the body at least partially surrounds the core and is configured to flex in response to contact with the waveguide at the second end.

18. The glasses assembly of claim 17, wherein:
the core defines a first length;
the first length decreases from the outer side to the inner side;
the body defines a second length; and
the second length increases from the outer side to the inner side.

19. The glasses assembly of claim 16, wherein:
the front cover and the waveguide define a gap that increases from the outer side to the inner side; and
the shroud at least partially disposed in the gap and defining a length increasing from the outer side to the inner side.

20. The glasses assembly of claim 16, wherein:
the first material comprises an electroactive polymer configured to receive a current;
the shroud is directly coupled with the waveguide; and
the waveguide is configured to move in response to the shroud receiving the current.
